(19) United States
(12) Patent Application Publication
(10) Pub. No.: US 2007/0284393 A1
(43) Pub. Date: Dec. 13, 2007

(54) Dosing Device with Capillary Air Supply

(76) Inventors: Stefan Ritsche, Eigeltingen (DE); Ralf Fichtner, Hilzingen-Weiterdingen (DE); Guenter Nadler, Moos-Iznang (DE)

Correspondence Address: FLYNN THIEL BOUTELL & TANIS, P.C., 2026 RAMBLING ROAD, KALAMAZOO, MI, 49008-1631, US

(21) Appl. No.: 11/662,312

(22) PCT Filed: Aug. 23, 2005
(86) PCT No.: PCT/EP05/09092

§ 371 Date: Mar. 8, 2007

(30) Foreign Application Priority Data
Sep. 9, 2004 (DE) 102004044344.0

(51) Int. Cl. B05B 11/00

(52) U.S. Cl. 222/189.09; 222/424.5

(57) ABSTRACT

The invention relates to a dosing device for at least one medium comprising a pump device, which is actively connected to a medium reservoir for discharging a medium, and comprising a venting device assigned to said medium reservoir. According to the invention, the venting device comprises a capillary channel, which forms a venting path between the medium reservoir and the surrounding area and whose channel length is larger by a multiple than its effective channel diameter. The inventive dosing device is provided for pharmaceutical or cosmetic purposes.

The invention relates to a dosing device for at least one medium, comprising a pump unit which is operatively connected to a medium reservoir for the purpose of discharging a medium, and comprising a venting device assigned to the medium reservoir.

A dosing device comprising a venting device is known from EP 1 295 644 A1. The dosing device is used for discharging a medium from a medium reservoir by means of a pump unit in several dispensing strokes that are separated from one another in time or that immediately succeed one another. For this purpose, the pump unit is in operative communication with the medium reservoir, allowing it to discharge medium from the medium reservoir and to discharge it into the environment of the dosing device. The medium in question can include liquid and solid substances and mixtures thereof, in particular ones that can be administered as medicaments. Depending on the medium that is to be discharged, minimum to maximum demands are placed on the dosing of the quantity of medium to be discharged by the pump unit and on the concentration of medically active ingredients possibly contained in said quantity. The pump unit can be designed, for example, for dispensing an atomized medium or for individual sprays of the medium. The venting device provided on the dosing device serves for pressure equalization between an internal pressure of a volume enclosed in the medium reservoir and an external pressure prevailing in the environment of the medium reservoir. A pressure difference may arise through the discharging of medium from the medium reservoir or also through thermally induced expansion or shrinkage of the medium or media contained in the medium reservoir. However, pressure differences in dosing devices of this kind are generally undesirable, since they can have a negative influence on the accuracy of the dosing of the medium that is to be discharged. Therefore, a pressure equalization between the internal pressure and the external pressure is permitted by means of the venting device, whereby gas from the environment can flow into the medium reservoir and gaseous or if appropriate also liquid or solid constituents of the medium can escape from the medium reservoir. This guarantees the pressure equalization and thus also the desired high level of dosing accuracy of the dosing device:

EP 1 295 644 A1 describes a venting device in which a pressure equalization aperture tapered like a nozzle is provided for pressure equalization between medium reservoir and environment. The extremely small opening diameter of the pressure equalization aperture of the venting device is intended to avoid undesired evaporation of medium from the medium reservoir. In addition, the dosing device according to EP 1 295 644 A1 can be provided with a filter unit which acts as a barrier against contaminating constituents of the outside air, preventing them from reaching the medium enclosed in the medium reservoir. Such a filter unit is intended to dispense with the need for agents for preserving the medium, because the air entering the medium reservoir during a pressure equalization between environment and medium reservoir is intended to be free from contaminating constituents. This is of considerable importance particularly in the case of medical substances.

The object of the invention is to make available a dosing device which has a reduced evaporation rate compared to known dosing devices.

This object is achieved by a dosing device of the type mentioned at the outset, in which the venting unit has a capillary channel which forms a venting path between the medium reservoir and the environment and whose channel length is larger by a multiple than its effective channel diameter. The effective capillary channel diameter is that diameter of a circular cross section whose surface area is identical to the surface area of any desired cross section of the capillary channel. The capillary channel can in particular have a round, rectangular or polygonal cross section, a circular cross section, or a cross section in the shape of a segment of a circle, or a combination of these. The length of the channel relates to its length extending from an end face directed toward the medium reservoir to an end face of the channel directed toward the environment.

Undesired escape of evaporated medium constituents can be reduced or prevented in an advantageous manner by the capillary channel. Evaporation of medium constituents occurs particularly through the action of heat on the dosing device. Depending on the vapor pressure of the medium enclosed in the medium reservoir, the evaporation causes an overpressure to form in the medium reservoir, and this can lead to the evaporated medium constituents flowing out of the medium reservoir through the venting device and into the environment. By virtue of the narrow cross section of the capillary channel, the venting device has a high degree of flow resistance that prevents rapid escape of evaporated medium constituents. Moreover, the capillary channel has the effect that the evaporated medium constituents that escape from the medium reservoir because of the vapor pressure are at least to a large extent held back in the venting path and mix only very slightly with the ambient air. In relation to a volume enclosed by the capillary channel, there is only a small cross section of interaction with the environment, such that mixing of the evaporated medium constituents with the ambient air is made difficult. In addition, because of the narrow cross section of the capillary channel in relation to its considerable length, a microclimate is advantageously created in the capillary channel, this microclimate having, relative to the environment, a higher concentration of evaporated medium constituents. This results from the fact that the narrow cross section of the capillary channel, in conjunction with its considerable length, substantially avoids volatilization of the evaporated medium constituents. This means that the evaporated medium constituents are once again available for suctioning into the medium reservoir, as may occur upon cooling of the medium reservoir or after a dispensing stroke of the dosing device. After the medium constituents stored temporarily in the capillary channel have been sucked back into the medium reservoir, a condensation of these medium constituents may even take place if appropriate. This ensures overall a lower evaporation of the medium enclosed in the medium reservoir, such that the dosing device according to the invention has a lower diffusion rate compared to known dosing devices. The solution according to the invention is suitable in particular for the dosing of pharmaceutical substances, but also for the dosing of cosmetic media.

By virtue of the lower degree of evaporation, and the associated low diffusion rate, an undesired change of the concentration of the stored medium, and of the active substances contained therein, can be avoided in the long term. An active substance enrichment of the medium caused by the evaporation of readily volatile medium constituents is largely avoided, with the result that the amount of active substance discharged per dispensing stroke also remains constant over quite a long period of time. Otherwise, in the case of a medium whose concentration was increased through evaporation, the pump unit designed for discharging a constant amount of medium would, from the same amount of medium, discharge a larger amount of active substance, which would lead to undesired fluctuations in the dosing of the medicament.

Stability tests are carried out in order to establish such behavior of the dosing device and of the medium received in it, especially for media which are to be used as medical active substances and which require precise dosing. In these tests, the change in the concentration of the medium is monitored over quite a long period of time and is evaluated on the basis of predefined limit values. One stability test involves determining to what extent the weight of the pump system decreases over quite a long period of time. Starting out from the original active substance concentration, this allows conclusions to be drawn concerning a change in the concentration of the active substance in the medium.

In one embodiment of the invention, the capillary channel, at least in some areas, has a ratio between an effective capillary channel diameter and a capillary channel length that is less than 1:4. At least in the area of an end directed away from the venting aperture of the medium reservoir, the capillary channel has a cross section with a ratio of effective capillary channel diameter to capillary channel length of less than 1:4. The capillary channel length is that length along which the capillary channel has a substantially constant effective channel cross section. As regards the design of the capillary channel, it is also conceivable that the capillary channel has a constant cross section along its length or that it has several portions with different diameters which, if appropriate, are delimited from one another by cross-sectional reductions. By means of a ratio of effective capillary channel diameter and capillary channel length of less than 1:4, a flow resistance, particularly for gaseous medium constituents, is generated, which leads to a reduced gas exchange with the environment, even when there is a considerable difference in concentration between the evaporated medium constituents, contained in the capillary channel, and the environment. Whereas a rapid mixing of the evaporated medium constituents with the environment takes place in known venting devices, this mixing takes place only to a much lesser extent in a dosing device with capillary channel, because of the increased flow resistance and the small cross section of interaction. In a preferred embodiment in the invention, the ratio of effective capillary channel diameter and capillary channel length is less than 1:10. In this way, conventional production methods such as are customarily used for dosing devices, in particular injection molding of plastic, can also readily be employed for producing an advantageous capillary channel which has a high degree of flow resistance and in which medium constituents with quite a high vapor pressure can also be effectively retained and are available for suctioning by the medium reservoir. In a particularly preferred embodiment of the invention, the ratio of effective capillary channel diameter and capillary channel length is less than 1:15. Capillary channel portions of this kind can be produced in particular by methods involving removal of material, for example laser drilling. In this way, suitable capillary channel portions can easily be formed in particular in thin layers, which are provided for example in plastic injection-molding techniques for delimiting the capillary channel. By virtue of the high ratio between effective capillary channel diameter and capillary channel length, a particularly advantageous flow resistance and a very small cross section of interaction are obtained, thereby ensuring a particularly advantageous retention effect of the capillary channel for evaporated medium constituents.

In another embodiment of the invention, the capillary channel is designed with an effective capillary channel diameter in a range of 0.1 mm to 0.5 mm and with a capillary channel length of 3 mm to 12 mm, preferably with an effective capillary channel diameter in a range of 0.15 mm to 0.25 mm and with a capillary channel length of 5 mm to 10 mm. An effective capillary channel diameter of this kind and a corresponding capillary channel length can easily be produced by injection molding of plastic, without the need for subsequent working of the structural parts produced. In this way, a particularly cost-effective venting device can be provided for applications in which either a slight change in concentration of the medium enclosed in the medium reservoir can be tolerated or the medium under normal circumstances has no real tendency to evaporation.

In another embodiment of the invention, the capillary channel is designed with a capillary channel diameter in a range of 0.01 mm to 0.1 mm and with a capillary channel length of 0.1 mm to 1 mm, preferably with a capillary channel diameter in a range of 0.02 mm to 0.05 mm and with a capillary channel length of 0.2 mm to 0.5 mm. Such dimensioning of the capillary channel is preferably achieved by methods involving removal of material, for example laser drilling. It is true that this requires subsequent working of the structural parts of the medium reservoir and/or of the pump device that are usually produced by injection molding of plastic, but this nonetheless guarantees the accuracy of the cross section of the capillary channel in a particularly advantageous way. Moreover, by virtue of the particularly small cross section of interaction, there is only a very slight mixing of the evaporated medium constituents with the environment.

In another embodiment of the invention, a filter arrangement is integrated in the venting path. By means of the filter arrangement, the slight degree by which the gas quantity stored mainly in the venting device is charged with contaminating substances can be further reduced. The degree by which the gas quantity provided for a suction operation of the medium reservoir is charged with contaminating substances is in any case to be regarded as low, because of the small exchange of the capillary channel with the environment, but it can still be further reduced by the filter arrangement. The filter arrangement can be provided at any desired position in the venting device. The filter arrangement is preferably arranged adjacent to the venting aperture of the medium reservoir or even closes this aperture, or the filter arrangement is provided at an end of the venting device directed away from the medium reservoir and thus forms a contamination barrier for the entire capillary channel. Thus, during a suction procedure of the medium reservoir, at least virtually uncontaminated gas, or completely uncontaminated gas, enters the medium reservoir, such that preservation of the medium enclosed in the medium reservoir can be completely omitted or at least almost completely omitted.

In another embodiment of the invention, the capillary channel is oriented coaxially to, or with its axis parallel to, an axis passing through the filter. This permits a particularly advantageous approach flow to a filter membrane provided in the filter unit, thereby also ensuring an advantageous barrier effect against contaminating substances.

In another embodiment of the invention, the capillary channel is designed integrally on the medium reservoir and/or on the pump unit. This permits particularly advantageous production of the capillary channel, for example by injection molding of plastic or by methods involving removal of material. In addition, it is thus possible to observe a particularly close dimensional and/or shape tolerance for the capillary channel, such that a flow characteristic of the evaporated medium constituents and of the gas possibly sucked in from the environment can likewise be defined with close tolerance. The capillary channel is advantageously designed as a passage with a closed hollow profile.

In another embodiment of the invention, the capillary channel has a first hollow profile which is integrated in the structural part and is open toward an adjacent structural part. The capillary channel is accordingly formed by the interaction of the adjacent structural parts, and the hollow profile can be introduced in particular as a groove with or without undercuts into the structural part. By means of a surface contact or slight spacing of the structural part provided with the open hollow profile and of the structural part arranged opposite it, the capillary channel is formed when the two structural parts are fitted together. By means of such a configuration, the hollow profile provided for the capillary channel can be easily introduced into the surface of the structural part during production of the latter, in particular by a profiling provided in the plastic injection mold, by removal of material, or by reshaping the substance of the structural part. In this way, complex courses of the capillary channel, for example serpentine hollow profiles, can also easily be obtained.

In another embodiment of the invention, the adjacent structural part has a corresponding, open second hollow profile which, together with the first hollow profile, forms a capillary channel. Particularly in structural parts of complex shape, it is in this way possible to obtain a constant cross section of the capillary channel, or also a cross section that changes in some areas. For example, the capillary channel on a convexly shaped portion of the first structural part may be only weakly pronounced, whereas in an opposite portion of the second structural part it is particularly strongly pronounced, in order together to ensure a desired cross section of the channel.

In another embodiment of the invention, the capillary channel, at least in some areas, has an annular configuration and extends coaxial to a longitudinal axis of the pump unit. By means of an annular configuration, a capillary channel can easily be created on which strict demands in respect of dimensional accuracy and tolerance can be placed. This is made possible in particular by a thin-walled attachment part which in some areas has a conical or cylindrical shape and which is fitted on the medium reservoir or on the pump unit and interacts with a corresponding portion of the medium reservoir or of the pump unit. A course of the annularly shaped capillary channel coaxial to a longitudinal axis of the pump unit permits a particularly advantageous construction of the dosing device since, in particular, a substantially rotationally symmetrical configuration of the structural parts can be chosen.

In another embodiment of the invention, the capillary channel, in particular at an interface between the medium reservoir and the pump unit, has at least one annular channel extending about the circumference at least in some areas. If the annular channel is provided at an interface between medium reservoir and pump unit, particularly simple fitting of the pump unit onto the medium reservoir is ensured, since the annular channel guarantees a communicating connection between the capillary channel portion on the medium reservoir and the capillary channel portion on the pump unit irrespective of its orientation about the longitudinal axis of the pump unit. The annular channel can be provided in a structural part assigned to the pump unit or to the medium reservoir, thereby also permitting simple, undirectional fitting of this structural part.

In another embodiment of the invention, the capillary channel is designed as a labyrinth system with at least two interconnected venting channel portions extending in different directions. On the one hand, a labyrinth system permits a particularly compact configuration of the capillary channel, and, on the other hand, the flow resistance can easily be increased by the diversion of the medium constituents or gases flowing in the capillary channel. In this way, an uncontrolled escape of the evaporated medium constituents from the capillary channel is made more difficult.

In another embodiment of the invention, the volume of the venting unit corresponds at least substantially to the volume of the amount of medium discharged with one dispensing stroke. It is thus possible to ensure that the volume of gas sucked in for pressure equalization in the medium reservoir originates completely from the capillary channel, with the result that, although gas from the environment is sucked into the capillary channel, this gas does not advance into the medium reservoir. It is thus possible to ensure a particularly low diffusion rate for the dosing device.

Further advantages and features of the invention will become clear from the claims and from the following description of preferred illustrative embodiments shown in the drawing, in which:

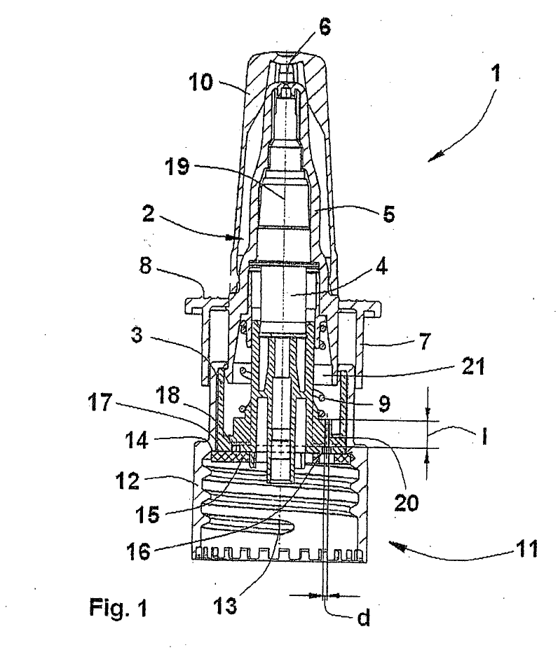

FIG. 1 shows a plane cross-sectional view of a dosing device, with a venting device that comprises an integrally designed capillary channel,

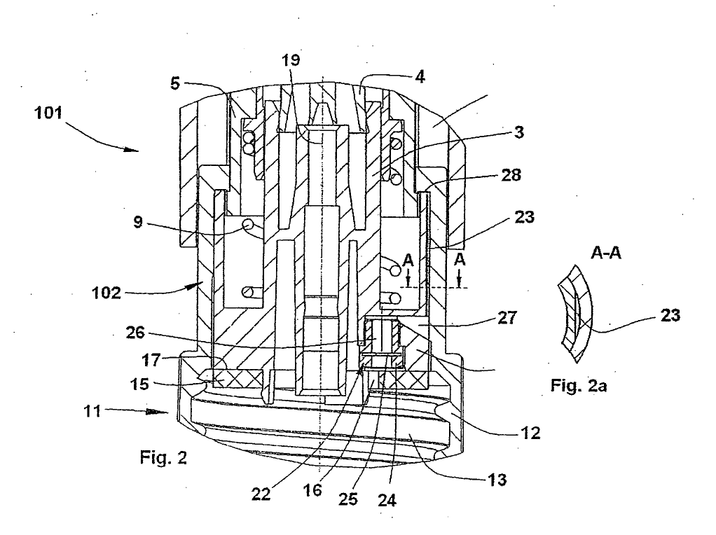

FIG. 2 shows, in a plane longitudinal section, an enlarged detail of a dosing device with a filter unit, and with a capillary channel formed between two structural parts,

FIG. 2a shows the capillary channel from FIG. 2 in a cross-sectional view along section line A-A,

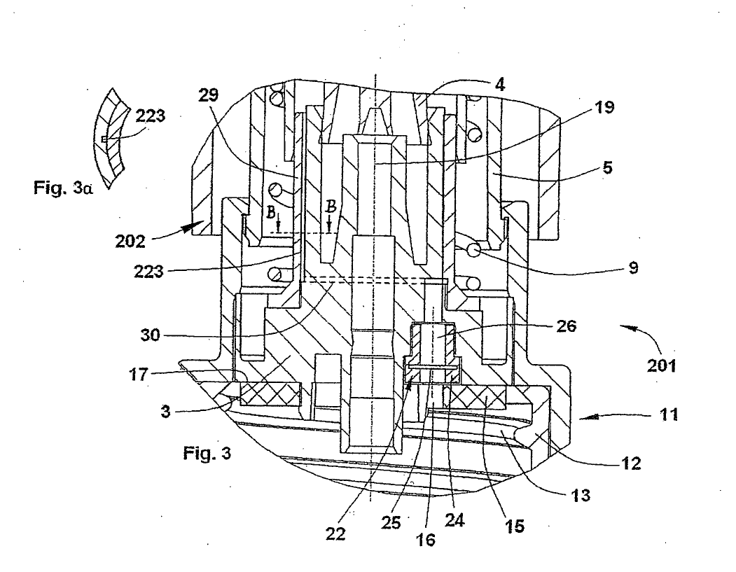

FIG. 3 shows, in a plane longitudinal section, an enlarged detail of a dosing device according to FIG. 2, with a filter unit, a capillary channel formed between two structural parts, and an annular channel,

FIG. 3a shows a cross section through the dosing device from FIG. 3 in the area of section line B-B in FIG. 3, and

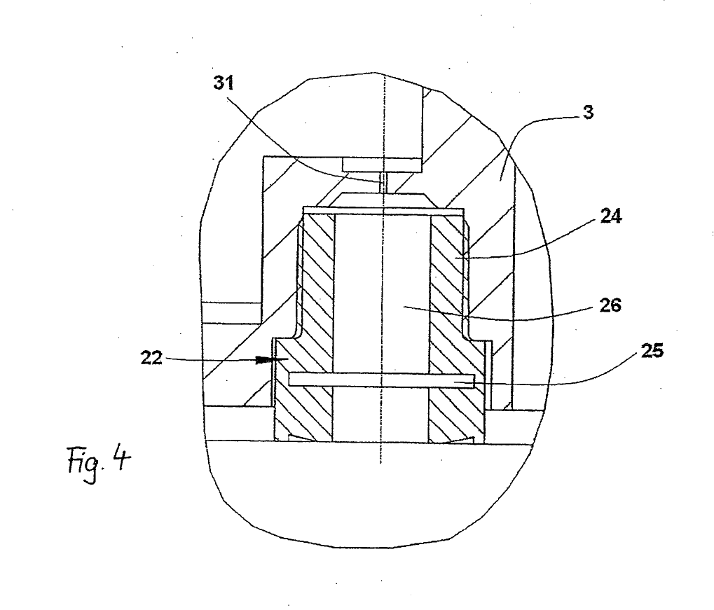

FIG. 4 shows, in a plane cross-sectional view, an enlarged detail of a filter unit for a dosing device with a downstream capillary channel.

The dosing device 1 according to FIG. 1 principally comprises a pump unit 2 which is intended to be mounted on a medium reservoir (not shown). The pump unit 2 comprises a schematically depicted piston arrangement 3 which is received in a likewise schematically depicted cylinder arrangement 4 and is intended to deliver the medium, held in the medium reservoir, into an environment outside the dosing device 1. The cylinder arrangement 4 is received in a substantially cone-shaped applicator 5 at whose narrowed end there is a discharge opening 6 through which the medium placed under pressure by the pump unit 2 can be discharged in finely atomized form to the environment. To initiate a relative movement, required for the discharge procedure, between the piston arrangement 3 and the cylinder arrangement 4, a handle 7 is provided which has finger rests 8. A user can thus actuate the dosing device 1 by pressing it between thumb and index finger/middle finger, the thumb being placed against a base (not shown) of the medium reservoir. To restore the piston arrangement 3 to the starting position according to FIG. 1, a restoring spring 9 is provided which, upon actuation of the dosing device 1, applies a restoring force. The applicator 5 is provided with a protective cover 10 which is taken off for the discharging procedure.

An interface 11 for application of the medium reservoir is provided at an end of the pump unit 2 remote from the discharge opening 6. The interface 11 has a substantially cylindrically shaped outer sleeve 12 which receives the piston arrangement 3 and is operatively connected with a form fit to the applicator 5 in such a way that they are movable relative to one another. The outer sleeve 12 is provided with an inner thread 13 which is provided for form-fit engagement of an outer thread provided on the medium reservoir. Bearing on a circumferential front collar 14 of the outer sleeve 12, there is a substantially circular flat seal 15 which is made of an elastic material and which is provided such that a bottle neck provided on the medium reservoir is sealed off from the pump unit 2. The flat seal 15 has a venting aperture 16 which is provided for communication between the environment and the volume enclosed by the medium reservoir. On a side directed away from the interface 11, the flat seal 15 bears in a substantially planar manner on an end face 17 of the piston arrangement 3. A circumferential venting groove 18 designed as a hollow profile, and with a rectangular cross section, is provided in the end face 17. The circumferential venting groove 18 communicates in turn with a capillary bore 20 which is designed as a capillary channel and which is oriented with its axis parallel to a longitudinal axis 19 of the pump unit 2. The capillary bore 20 opens into a hollow space 21 which is delimited by the piston arrangement 3, the outer sleeve 12 and the applicator 5 and which in turn communicates with the environment via slits (not shown) and thus permits an exchange of gases, in particular ambient air. For the sake of clarity, the venting groove 18 and the capillary bore 20 are not shown true to scale in FIG. 1, but slightly enlarged, but it will be seen that the length l of the capillary bore is larger by a multiple than the diameter d of the capillary bore. The venting aperture 16, the venting groove 18, the capillary bore 20 and the hollow space 21 thus form the venting unit of the dosing device 1. A venting path designed as capillary bore 20 is thus provided on the venting unit, i.e. a flow of gas emerging from the medium reservoir, for example a flow of evaporated constituents of the medium, must by necessity flow through the venting device in order to escape into the environment. The same applies to the reverse procedure, namely where gas is sucked from the environment into the medium reservoir. In this case too, it has to flow entirely through the venting unit.

In the enlarged details shown in FIGS. 2 to 4, the same reference numbers as in FIG. 1 are used for identical or functionally equivalent components.

In the dosing device 101 depicted in FIG. 2, and shown only as an enlarged detail, the areas not illustrated here have essentially the same structure as in the dosing device 1 shown in FIG. 1. A difference from FIG. 1 is that the dosing device 101 is additionally provided with a filter arrangement 22 in the venting unit, which filter arrangement 22 communicates with a capillary channel designed as a hollow profile 23. The filter arrangement 22 has a filter cartridge 24 and a filter membrane 25, which is designed as a germ barrier and is received in a through-bore 26 of the filter cartridge 24. Alternatively, in an embodiment not shown here, the filter membrane can be laminated onto the filter cartridge. A longitudinal axis of the through-bore 26 is oriented parallel to the longitudinal axis 19 of the pump unit 102. The filter membrane 25 is intended to ensure that contaminants from the environment cannot get into the medium reservoir (not shown). The filter cartridge 24 is arranged on the piston arrangement 2 and is able to communicate with the medium reservoir via the venting aperture 16 in the flat seal 15. On a side directed away from the interface 11, the through-bore 26 communicates with a gas reservoir 27 formed between the outer sleeve 12, the filter cartridge 24 and an insert part 28 provided for locking the filter cartridge 24. The gas reservoir 27 is in turn connected to the hollow profile 23 which is formed between a substantially cylindrically shaped outer face of the piston arrangement 3 and a correspondingly shaped inner face of the outer sleeve in planar contact with the piston arrangement 3. The hollow profile 23, as shown in more detail in the cross-sectional view A-A in FIG. 2a, is designed as a flattening of the substantially cylindrically shaped outer face of the piston arrangement 3 and therefore forms, with the adjacent inner face of the outer sleeve 12, a channel profile in the shape of a segment of a circle. At an end of the hollow profile 23 directed away from the gas reservoir 27, the capillary channel opens into a labyrinth gap 28 which in turn communicates with the hollow space 121. In the embodiment shown in FIG. 2, the labyrinth gap 28 is only to be regarded as an auxiliary to the capillary gap since, because of the relative mobility between applicator 5 and outer sleeve 12, it is provided with rough dimensional tolerances in order to guarantee the mobility of the structural parts. However, it is also conceivable to configure the labyrinth gap 28 such that it acts as a capillary gap and permits an especially space-saving arrangement of the venting device.

The embodiment of the invention shown in FIG. 3 is based essentially on the embodiments in FIGS. 1 and 2. In FIG. 3, by contrast to FIGS. 1 and 2, a thin-walled attachment part 29 is provided which is assigned to the pump unit 202 and which has a circumferential annular channel 30, and a hollow profile 223, shown in more detail in FIG. 3a. The attachment part 29 is fitted onto the piston arrangement 3 and locked with a form fit. Alternatively, it is possible for the attachment part to be mounted on the piston arrangement with a force fit. Because of the annular channel 30, the attachment part 29 can be mounted on the piston arrangement 3 in any desired way with respect to its rotational orientation about the longitudinal axis 19 of the pump unit 202, since a communicating connection with the through-bore 26 of the filter cartridge 24 is ensured in every position. The thin-walled attachment part has, on an inner face, a groove 31 which is oriented parallel to the longitudinal axis and which is shown in more detail in FIG. 3b. Together with the cylindrically shaped outer face of the piston arrangement 3, this groove 31 forms the desired capillary gap. This construction of the venting device ensures that the piston arrangement 3 and the thin-walled attachment part 29 can be produced in a simple way and with narrow tolerances, such that the capillary gap formed by these structural parts likewise has particularly narrow tolerances. For different media that are to be discharged by the pump unit 202, different cross sections of the capillary channel can advantageously be obtained by using different attachment parts 29.

In the embodiment of the invention shown in FIG. 4, a capillary channel is provided directly downstream of the filter cartridge 24. The capillary channel is provided in a wall section of the piston arrangement 3 in which the filter cartridge 24 is received. For the sake of clarity, the capillary bore 31 is shown slightly enlarged and has, in a practical embodiment, a bore length that is larger by a multiple than the bore diameter. The capillary bore 31 is formed into the wall section by a manufacturing method involving material removal or cutting, in particular by laser drilling.

All the embodiments of the invention function in essentially the same way. The required pressure equalization between an internal pressure prevailing in the medium reservoir and an external pressure prevailing in the environment of the dosing device is ensured via the venting unit. Pressure differences between internal and external pressures may occur in particular through heating or cooling of the dosing device, which leads to an expansion or reduction of the volume of the medium held in the medium reservoir and of the volume of the gas constituents also located in the medium reservoir. In an initial state of the dosing device immediately after it is filled with medium, the gas constituents can mainly consist of ambient air remaining in the medium reservoir or of a protective gas actively filled into the medium reservoir. The evaporated medium constituents that issue from the medium during heating of the dosing device mix together with these gas constituents. In a dosing device that has already performed a number of dispensing strokes by which medium has been discharged from the medium reservoir, a mixture is present which consists of the gas constituents that were present during filling of the medium reservoir together with the evaporated medium constituents and the air gases from the environment.

To ensure a low diffusion rate for the dosing device, the venting path of the venting device is provided with the at least one capillary channel that prevents unimpeded escape of the gas mixture present in the medium reservoir. This is achieved by the fact that the capillary channel offers a high flow resistance to the gas mixture and provides, in respect of the environment, only a small surface of interaction which would allow the gas emerging from the medium reservoir to mix with the air gas of the environment. Upon reduction of the volume of the medium or gas mixture received in the medium reservoir, or after a dispensing stroke, there is a negative pressure difference in the medium reservoir relative to the environment. To compensate for this pressure difference, air gas has to flow from the environment into the medium reservoir. If the venting device has a volume equal to or greater than the volume needed for the pressure equalization, said pressure equalization can be effected completely by aspiration of the gas mixture received in the venting device. This results in only an inappreciable change of the concentration of the medium constituents present in the gas mixture in the medium reservoir, such that additional evaporation or dissolution of medium constituents caused by the possibly high concentration of evaporated medium constituents is at least reduced. This means that it is possible, over quite a long period of time, to avoid or reduce an undesired escape of readily volatile medium constituents.

In an embodiment not shown, the venting device is designed as an antechamber to the venting aperture of the medium reservoir and has only one or a small number of venting openings with extremely small cross sections. In this way, the desired microclimate can be obtained in a particularly advantageous manner in the antechamber, the air charged with evaporated constituents does not flow off and can be sucked into the medium reservoir again at the next pressure equalization.

In another embodiment of the invention not shown here, a volume of the venting device, from the medium reservoir to the mouth of the capillary channel, is dimensioned such that this volume is equal to or greater than the volume discharged by the pump device with one dispensing stroke. It is thus possible to ensure that the gas volume sucked into the medium reservoir after a dispensing stroke originates entirely from the area of the venting device in which the microclimate according to the invention prevails.

1. A dosing device for at least one medium, comprising a pump unit (1, 101, 201) which is operatively connected to a medium reservoir for the purpose of discharging a medium, and comprising a venting unit assigned to the medium reservoir, characterized in that the venting unit comprises a capillary channel (20, 23, 31) which forms a venting path between the medium reservoir and the environment and whose channel length is larger by a multiple than its effective channel diameter.

2. The dosing device as claimed in claim 1, characterized in that the capillary channel, at least in some areas, has a ratio between an effective capillary channel diameter (d) and a capillary channel length (l) that is less than 1:4, preferably less than 1:10, particularly preferably less than 1:15.

3. The dosing device as claimed in claim 1, characterized in that the capillary channel is designed with an effective capillary channel diameter in a range of 0.1 mm to 0.5 mm and with a capillary channel length of 3 mm to 12 mm, preferably with an effective capillary channel diameter in a range of 0.15 mm to 0.25 mm and with a capillary channel length of 5 mm to 10 mm.

4. The dosing device as claimed in claim 1, characterized in that the capillary channel is designed with an effective capillary channel diameter in a range of 0.01 mm to 0.1 mm and with a capillary channel length of 0.1 mm to 1 mm, preferably with an effective capillary channel diameter in a range of 0.02 mm to 0.05 mm and with a capillary channel length of 0.2 mm to 0.5 mm.

5. The dosing device as claimed in claim 1, characterized in that a filter arrangement (22) is integrated in the venting path.

6. The dosing device as claimed in claim 5, characterized in that the capillary channel is oriented coaxially to, or with its axis parallel to, an axis passing through the filter.

7. The dosing device as claimed in claim 1, characterized in that the capillary channel is designed integrally on the medium reservoir and/or on the pump unit.

8. The dosing device as claimed in claim 7, characterized in that the capillary channel is designed as a passage with a closed hollow profile (20, 31).

9. The dosing device as claimed in claim 7, characterized in that the capillary channel has a first hollow profile (23) which is integrated in one structural part and is open toward an adjacent structural part.

10. The dosing device as claimed in claim 9, characterized in that the adjacent structural part has a corresponding, open second hollow profile which, together with the first hollow profile, forms the capillary channel.

11. The dosing device as claimed in claim 1, characterized in that the capillary channel, at least in some areas, has an annular configuration and extends coaxial to a longitudinal axis (19) of the pump unit.

12. The dosing device as claimed in claim 1, characterized in that the capillary channel, in particular at an interface (11) between the medium reservoir and the pump unit, has at least one annular channel (30) extending about the circumference at least in some areas.

13. The dosing device as claimed in claim 1, characterized in that the capillary channel is designed as a labyrinth system with at least two interconnected capillary channel portions extending in different directions.
